(19) United States
(12) Patent Application Publication
(10) Pub. No.: US 2015/0375154 A1
(43) Pub. Date: Dec. 31, 2015

(54) APPARATUS FOR CREATING CONSTANT STREAM OF PURIFIED AIR

(71) Applicant: Jie Rui Lai, Pebble Beach, CA (US)

(72) Inventor: Jie Rui Lai, Pebble Beach, CA (US)

(21) Appl. No.: 14/752,354

(22) Filed: Jun. 26, 2015

Related U.S. Application Data
(60) Provisional application No. 62/018,543, filed on Jun. 28, 2014.

(51) Int. Cl. B01D 46/00; B01D 46/42

(52) U.S. Cl. CPC B01D 46/0047; B01D 46/42

(57) ABSTRACT

An air purifying apparatus comprising a housing to direct ambient air flow through a filter to remove pollutants and a multi-section nozzle for controlling outflow of purified air. The nozzle receives purified air from the filter and directs it through an annular ring disposed at the outer perimeter of the nozzle to produce a fast-moving, high pressure zone of air and through a central section within the outer perimeter thereof to produce a slower-moving, low pressure zone of air. The high pressure margin contained in the perimeter of the out flow of purified air prevents untreated ambient air from mixing with the low pressure purified air and isolates the purified low pressure zone. A grid of guiding veins in the nozzle controls the air flow for an even flow of purified air.

### CROSS-REFERENCE TO RELATED APPLICATIONS

This application is entitled to the benefit of, and claims priority to U.S. Provisional Application entitled “Device for Creating Constant Stream of Purified Air”, Ser. No. ______, filed on Jun. 28, 2014.

### BACKGROUND OF THE INVENTION

Personal use and portable air purifiers are widely used in places where there are high. levels of pollution in the environment both indoors and outside. These purifiers usually blow air through a High Efficiency Particulate Air filter, or HEPA filter, to remove contaminants from the air. However, these devices have some severe limitations in their ability to deliver the purified air to the user. After the air exits the device it almost immediately mixes with the unfiltered ambient air in the environment, which reduces its effectiveness. This forces the device to process a larger volume of air multiple times in order to remove enough pollutants to be effective. These are also nearly useless in large rooms or outside because of the amount of air that needs to be processed.

### SUMMARY OF THE INVENTION

This apparatus is an air purifier. The purpose of this invention is to deliver purified air directly to the user's face, mouth and nose after passing through the filter. This is accomplished by creating a constant airflow that is capable of retaining its purity from ambient pollutants until it has travelled far enough to reach the user. It can provide the user with purified air instantly, and is not limited by the volume of air in a room. It can be used outdoors with varying results depending on outside conditions, such as wind.

### BRIEF DESCRIPTION OF THE DRAWINGS

FIG. 1 represents a cutaway side view of the apparatus.

FIG. 2 represents a front perspective of the nozzle end of the apparatus.

FIG. 3 represents a cutaway side view of another embodiment of the nozzle of the apparatus.

### DETAILED DESCRIPTION OF THE INVENTION

The following detailed description is of the best currently contemplated modes of carrying out exemplary embodiments of the invention. The description is not to be taken in a limiting sense, but is made for at least the purpose of illustrating the general principles of the invention, since the scope of the invention is best defined by the appended claims.

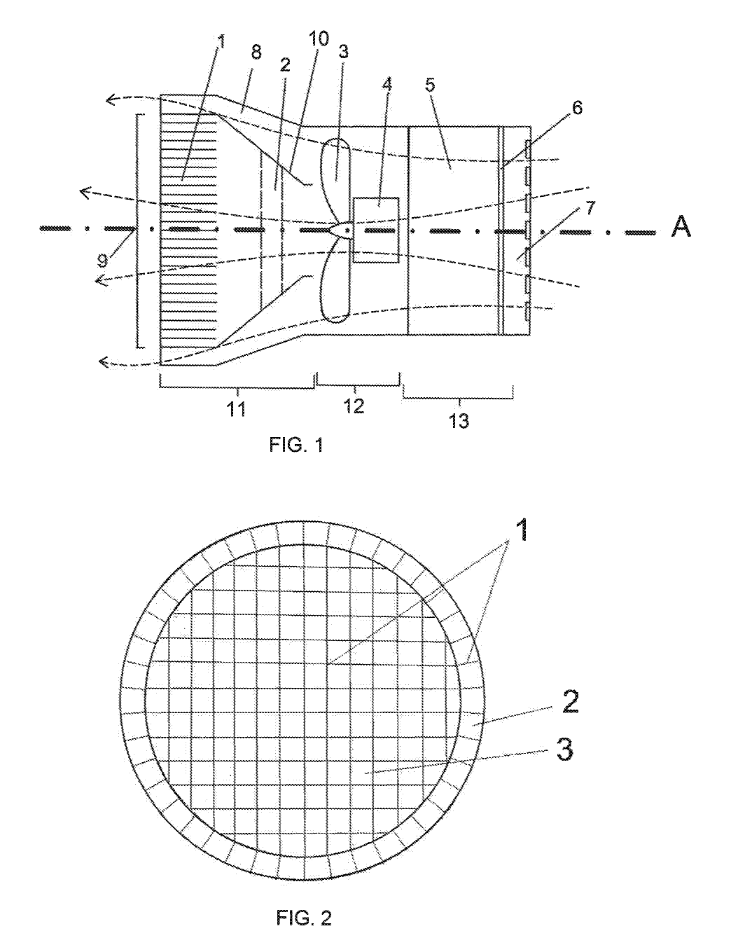

Referring to the drawings, FIG. 1 refers to one embodiment. This apparatus functions by fan blades 3 and a motor 4 that pushes or draws air through the apparatus. When the ambient air is drawn into the air intake 7 of the apparatus by the fan 12, the airflow passes through one or more filters 13 located in the apparatus near the center or the rear of the housing for purification. In one embodiment of the invention, the airflow passes first through a pre-filter 6, such as a coarse filter to remove larger pollutants, and then the airflow passes through a HEPA filter 5, for removing finer pollutants. The filters 13 utilized in this apparatus may be replaceable, permanent, or any combination thereof depending on the type of filter.

After passing through the filters 13, the airflow is directed toward a nozzle 11, which includes an airflow separator 10, where the airflow may be directed through a plurality of sections by the airflow separator 10.

in one embodiment the housing for the apparatus is cylindrical. The nozzle 11 is split into two sections by the separator 10; an interior section or inner circle 9 and an annular section or outer ring 8 that surrounds the inner circle 9. The purified air that is directed out of the apparatus through the outer ring 8 flows through a narrowing passage resulting in a low pressure ring with fast airflow. The airflow that is directed through the middle circle 9 flows through a widening passage creating a high pressure zone with slower airflow.

The faster, low pressure airflow passing through the outer ring 8 of the nozzle 11 creates a perimeter of faster airflow encircling the slower high pressure airflow from the inner circle 9. Through Bernoulli's Principle the faster, low pressure airflow in the outer ring 8 flows like a curtain of air which prevents the ambient air from mixing into the purified air in the inner circle 9 and isolates the purified airflow flowing out of the apparatus through the inner circle 9 of the nozzle 11 from diffusing into, or mixing with ambient air as it is directed toward the user. Thus, it is impossible for the purified air to be contaminated with outside pollutants because the outer airflow has a lower pressure than the inner airflow, therefore all of the air that is processed by the device will flow in one direction towards the outside.

Further, the zone of slower flowing, high pressure purified airflow flowing out of the inner circle 9 of the nozzle 11 will cause less discomfort for the user and act to reduce the workload of the apparatus to function more efficiently and economically.

Additionally, a grid of air guiding vanes 1 may be utilized on the nozzle 11 to break up or direct the airflow as it flows out of the apparatus so that it flows evenly toward the user and cause less discomfort.

In another embodiment, the fan 12 is situated at the end of the apparatus closest to the air intake 7. The fan 12 draws ambient air in through the air intake 7 and directs it then through the air filters 13 where the ambient air is purified and directed toward the nozzle 11.

Other embodiments of the apparatus may feature housing and a nozzle that is a shape other than cylindrical.

In all embodiments the fan 12 may be any type of fan, including a radial fan with blades, a centrifugal fan, or any fan capable of passing air through the apparatus housing.

Where the apparatus is oriented with a fan 12 located axially near the center of the apparatus, said fan 12 draws air into the air intake 7, then through a filter or multiple filters 13 and then directs the purified airflow toward the nozzle 11. In such an orientation there may be a diffuser 2 located inside the inner circle 9 of the nozzle 11. The diffuser 2 dampens the airflow directed through the inner circle 9 and further reduces any discomfort the user may experience from turbulent airflow directed toward them.

FIG. 2 refers to one embodiment where a grid of air guiding vanes 1 may be utilized on the nozzle [FIG. 1 11] to break up or direct the airflow as it flows out of the apparatus so that it flows evenly toward the user. The disposition of air guiding vanes for the outer ring 2 and the inner circle 3 may vary.

The effect of the apparatus is a zone of purified high pressure airflow directed through the apparatus, out of the nozzle 11, and toward the user for safe, comfortable enjoyment. The high pressure zone is surrounded by a circumference of faster moving low pressure air that acts as a curtain to prevent the pollutants from mixing into the high pressure zone and to isolate said high pressure zone to ensure it travels far enough to reach the user without becoming tainted with ambient pollutants.

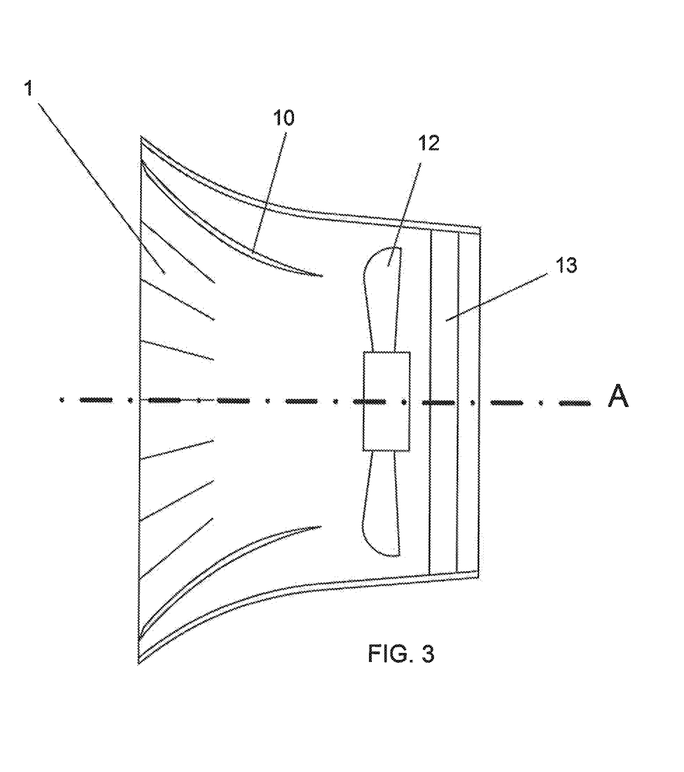

FIG. 3 refers to another embodiment of the nozzle of the apparatus in which the zone of purified airflow flowing toward the user is increased in circumference. The rim of the nozzle [FIG. 1 11] is outwardly angled at the evacuating end of the device. The fast flowing, low pressure airflow evacuating from the apparatus through the outer ring [FIG. 1 8] is guided in a more conical shape as it evacuates. The effect is that both the fast flowing, low pressure zone of purified airflow and the inner circle of slower flowing, high pressure zone of purified airflow create a wider zone of purified airflow. This increases the comfort for the user and the effectiveness of the apparatus.

It should be understood that the foregoing relates to exemplary embodiments of the invention and that modifications may be made without departing from the spirit and scope of the invention. It should also be understood that the present invention is not limited to the designs mentioned in this application and the equivalent designs in this description, but it is also intended to cover other equivalents now known to those skilled in the art, or those equivalents which may become known to those skilled in the art in the future.

What is claimed is:

1. An air purifying apparatus comprising:
housing, having an axis, at least one intake for receiving ambient air and an outflow for evacuating air therefrom;
multi-section nozzle axially disposed at the outflow of the housing and having air guiding passages disposed in an annular ring section around the perimeter thereof to produce a low pressure zone of air at the outer perimeter of the evacuating air, and air guiding passages disposed within the outer perimeter to produce a high pressure zone within the outer perimeter of the evacuating air;
fan axially mounted inside the housing for moving air through the housing; and
air filter, axially mounted in the housing, to remove pollutants from the air as it flows though the housing.

2. The air purifying apparatus in claim 1, wherein the air guiding passages comprise a grid of guiding vanes in the nozzle to produce even airflow toward the user.

3. The air purifying apparatus in claim 1 wherein ambient air is prevented from mixing into the evacuated purified air at the outflow of the apparatus.

4. The air purifying apparatus in claim 1 wherein evacuated purified air is isolated from ambient air at the outflow of the apparatus.

5. The air purifying apparatus in claim 1 further comprising at least one replaceable filter.

6. A method for isolating purified air from the outflow of an air purifier, the method comprising the steps of:
receiving ambient air at an intake of a housing;
moving air through a multi-section nozzle axially disposed at the outflow of the housing, the nozzle having air guiding passages disposed in an annular ring section around the perimeter thereof to produce a low pressure zone of air at the outer perimeter of the evacuating air and air guiding passages disposed within the outer circumference to produce a high pressure zone within the outer perimeter of the evacuating air;
moving air within the housing through an axially mounted air filter to remove pollutants from the air as it flows through the housing; and
evacuating purified air isolated from the ambient air at the outflow of the housing.

7. The method of claim 6, wherein the step of evacuating purified air includes the step of evacuating a laminar flow of purified air.
